(19) United States
(12) Patent Application Publication
(10) Pub. No.: US 2025/0322230 A1
(43) Pub. Date: Oct. 16, 2025

(54) System and method for mitigating biases in a machine learning model during post-processing

(71) Applicant: Bank of America Corporation, Charlotte, NC (US)

(72) Inventors: Ngoc A. Tran, Charlotte, NC (US); Maneesh Kumar Sethia, Telangana (IN); Sivashalini Sivajothi, Tamil Nadu (IN)

(21) Appl. No.: 18/634,309

(22) Filed: Apr. 12, 2024

(51) Int. Cl. G06N 3/08

(52) U.S. Cl. CPC G06N 3/08

(57) ABSTRACT

A system for mitigating biases during the testing of a machine learning model is disclosed. The system tests the machine learning model by inputting a set of real-world input data to the machine learning model, receiving a set of outputs from the machine learning model, and evaluating at least one of the set of outputs against a respective expected output. The respective expected output is determined based on a historical record associated with the set of real-world input data. The system determines that more than a threshold percentage of outputs from among the set of outputs differ from respective expected outputs. In response, the system determines that the machine learning model is biased. The system updates the machine learning model by updating one or more parameters of a neural network of the machine learning model.

### TECHNICAL FIELD

The present disclosure relates generally to anomaly detection, and more specifically to a system and method for mitigating biases in a machine learning model during post-processing.

### BACKGROUND

Machine learning models are trained using training datasets to learn patterns and relationships within the datasets. The machine learning models may be used to predict a trend in given inputs and classify the inputs.

### SUMMARY

The system described in the present disclosure is particularly integrated into practical applications of improving bias detection and mitigation techniques in machine learning model development, training, and deployment processes. This approach provides technical advantages and improvements such as improved performance of machine learning models and reduced computational resources to implement the machine learning models.

In current systems, artificial intelligence (AI) biases are anomalies in the output of the machine learning models. For example, AI biases may occur due to prejudiced assumptions made during the model development process and/or in the process of data sampling and labeling for generating the training dataset. In some cases, biases may occur when a machine learning model produces results that are systematically biased due to erroneous assumptions in the machine learning process. A biased training dataset may cause inconsistencies and does not represent the machine learning model's accuracy and performance accurately, and therefore, leads to skewed outputs, systematic prejudice, and low prediction accuracy. Typically, a biased training dataset and/or a biased machine learning model skews the results of the machine learning model in favor or against a particular set of datapoints and the error may occur between the average of model prediction and the ground truth (i.e., expected output known to be true).

The disclosed system is configured to provide a solution to these and other technical problems raised by biased datasets and biased machine learning algorithms. In some embodiments, the disclosed system is configured to detect at which stage of the life cycle of a machine learning model a bias is detected. For example, the system determines whether a bias is detected before the training process of the machine learning model (i.e., during pre-processing), during the training process of the machine learning model (i.e., during in-processing), or during the testing stage of the machine learning model (i.e., post-processing). In response to detecting a bias, the system is configured to mitigate the bias. For example, a bias may be due to the under-sampling of data and/or over-sampling of data in the training dataset, personal views, and experiences of developers of the machine learning model that have affected the development of the machine learning model, among others.

The system is configured to detect whether there is any bias in the dataset before the training of the machine learning model (i.e., during pre-processing) by comparing the dataset with the expected dataset. If any anomaly or inconsistency between each datapoint of the dataset and the counterpart datapoint of the expected dataset is detected, this may be an indication of a bias in the training dataset.

In the pre-processing, the bias may be caused by and/or associated with a missing datapoint from the training dataset (that is found in the expected dataset), inconsistent labels of two or more corresponding datapoints, missing features from a datapoint, and incompatible label/datapoint with the machine learning model, among other inconsistencies. In response, the disclosed system may add the missing datapoints to the training dataset, change the inconsistent labels to an updated label that is consistent across corresponding datapoints, add a feature data (or feature vector) to a datapoint that is missing the feature data (or the feature vector), and change the data structure of an incompatible label/datapoint to another data structure that is compatible with the machine learning model. In this manner, the disclosed system transforms the training dataset to reduce or otherwise minimize the biases in the training dataset.

The disclosed system is configured to detect whether there is any bias in the dataset and/or the machine learning model during the training of the machine learning model (i.e., during in-processing) by comparing the output of the machine learning model with the expected output. For example, if the disclosed system determines that the output of the machine learning model does not correspond to the expected output, it may be an indication of a bias in the training dataset and/or the machine learning model. For example, if a similar output is generated for multiple different input data for several iterations, it may be an indication of a bias in the training dataset and/or the machine learning model. In response to detecting a bias, the disclosed system identifies the datapoints that were caused by the bias, and updates their labels and/or features to mitigate the bias. For example, the disclosed system may change the label and/or features of a datapoint to correspond to a label and/or features of a counterpart expected datapoint, respectively.

For example, the disclosed system may access the historical records of a datapoint that is identified to be associated with a bias (e.g., missing, irrelevant, incompatible, or incorrect label and/or feature) and update the label and/or feature of the datapoint based on the historical records such that the updated label and/or feature correspond to that indicated in the historical record. In this manner, the disclosed system may remedy the detected biases and generate an updated training dataset and machine learning model with reduced biases.

During the post-processing, the disclosed system deploys the trained machine learning model and obtains output from the machine learning model. The output of the machine learning model may be the model's prediction based on a given input. The disclosed system may determine whether the output is biased. For example, the disclosed system may determine the accuracy score of the machine learning model. If, for example, the accuracy score of the machine learning model is less than a threshold score (e.g., less than 30%, 20%, etc.), it may be an indication of bias in the machine learning model and/or the training dataset. Thus, in one example, If the machine learning model's performance does not align with the expected accuracy threshold, the disclosed system may flag this discrepancy as a potential bias.

As another example, the disclosed system may compare the outputs of the machine learning model with real-world data and associated expected outcomes. If the predicted output of the machine learning model deviates from the real-world data patterns and associated expected outcomes, this discrepancy is flagged as a potential bias. Upon detecting such a bias, the disclosed system may take corrective actions. In this process, the system may assess the machine learning model's output in detail to identify specific areas where the predictions do not correspond to the expected outcome. For example, the discrepancy many include missing features, incorrect labels, or other anomalies that suggest a bias. In response to identifying the anomalous areas in the output, the disclosed system may adjust the machine learning model by recalibrating (e.g., changing) the labels of input data, recalibrating (e.g., changing) the labels of the output data, and adding any missing labels and features that were identified during the comparison stage.

In addition to these corrections, the disclosed system iterates through a feedback loop to continually adjust the machine learning model and/or the training dataset by evaluating and updating the labels and features of the datapoints within the training dataset and the output of the machine learning model (if needed). This loop includes reassessing the machine learning model's predictions against the expected output data to determine whether all features and labels are accurately represented and whether the predicted outputs correspond to the expected output. The post-processing correction enables the machine learning model to adapt over time, which, in turn, increases the predictive accuracy and fairness of the model. If the accuracy score of the machine learning model is less than the threshold score, the feedback and adjustment cycle may continue until the machine learning model achieves at least the threshold accuracy score or higher, which may indicate that the biases are reduced or minimized. Thus, the disclosed system facilitates that the machine learning model is dynamic and is able to self-correct in response to ongoing input and performance evaluation.

In this manner, in some embodiments, the disclosed system is configured to detect and mitigate biases in pre-processing, in-processing, and post-processing stages of a machine learning model. Thus, the disclosed system improves the bias detection and mitigation techniques by implementing a multi-stage framework that addresses potential biases at each phase of a machine learning model's development, testing, and deployment. With the reduced biases in the training dataset and the machine learning model, the performance and accuracy of the machine learning model are increased.

In some embodiments, the disclosed system is configured to conserve the processing and memory resources of the computing device. For example, the disclosed system identifies at which stage of the life cycle of the machine learning model a bias is detected and zones in to investigate that particular stage. Thus, the computing device may allocate processing and memory resources to specifically address the detected bias at its source rather than expending processing and memory resources across all stages of the machine learning lifecycle.

For example, if a bias is detected during the pre-processing stage, the disclosed system allocates its processing and memory resources to analyze and rectify the data at this stage. Thus, the disclosed system may reduce the probability of the propagation of biased data through subsequent stages (namely training and testing stages). Therefore, the disclosed system implements a targeted correction technique to avoid unnecessary reprocessing of data in later stages, which would require additional computational power.

Similarly, if a bias is detected during the in-processing (training) stage, the disclosed system may adjust the training process, such as by modifying the labels and features of datapoints in the training dataset, and parameters of the neural network of the machine learning model (e.g., weights and bias values), to reduce the inadvertently injected bias. Therefore, the disclosed system obviates the need for comprehensive retraining or post-hoc corrections that are more resource intensive.

Furthermore, by detecting and mitigating biases during the training stage of the machine learning model, the bias is not propagated downstream to subsequent stages, such as refining and testing. This leads to reducing anomalies caused by the bias in the later stages. Thus, the refining and testing stages are carried out based on a more accurate model foundation. Thus, this obviates the need for later corrections and modifications in the later stages. This, in turn, increases the reliability and accuracy of the machine learning model. Furthermore, early-detection and mitigation of biases during the training stage of the machine learning model leads to conserving computational and memory resources that would otherwise be spent on the detection and addressing the biases in later stages that are computationally complex.

If biases are not corrected early, they may propagate through the life cycle of the machine learning model and lead to compound errors that are more challenging and resource-intensive to address and correct. Thus, early bias detection and mitigation conserve overall computational resources spent on implementing the machine learning model.

In the post-processing stage, if the disclosed system detects a bias, the disclosed system applies targeted adjustments to the machine learning model's output or its decision-making criteria to correspond to the expected output associated with real-world data. This, in turn, leads to spending less processing and memory resources that would otherwise be spent on retraining and reconstructing the machine learning model. More specifically, retraining the machine learning model, especially with large datasets, is computationally extensive and time consuming. However, by implementing the disclosed system in the post-processing stage, surgical adjustments and refinements may be made in the neural network parameters of the machine learning model to adjust the machine learning model's output based on the expected output and mitigate the detected biases in the machine learning model. This helps to avoid the complete reconstruction and retraining the machine learning model from scratch, and thereby, conservers computation and memory resources. For example, in surgical adjustments and refinements, the neural network parameters (e.g., weight and bias values) that contribute to the bias are identified and updated such that the output of the model is more closely aligned with the expected output. This process may occur through an iterative process until the model's output is more closely aligned with the expected output.

Furthermore, by mitigating biases in the post-processing of the machine learning mode, the accuracy of the machine learning model is increased because the outputs that are inaccurate (i.e., deviate from the expected real-world outputs) are corrected to align more closely to the expected real-world outputs. Thus, the precision of the machine learning model is increased.

### Mitigating Biases in a Training Dataset for a Machine Learning Model in Pre-Processing

In some embodiments, a system for mitigating biases in a training dataset for a machine learning model comprises a memory operably coupled to a processor. The memory is configured to store a machine learning model and a training dataset, wherein the training dataset comprises a set of datapoints. The processor is configured to determine that the training dataset is biased. In some embodiments, determining that the training dataset is biased comprises determining that the training dataset is missing at least one expected datapoint; determining that a first datapoint, in the training dataset, is associated with a first label that is incompatible with a machine learning model; or determining that a second datapoint, in the training dataset, is associated with an incorrect label compared to a counterpart expected datapoint. In response to determining that the training dataset is biased, the processor is further configured to generate a transformed training dataset. In some embodiments, generating the transformed training dataset comprises at least one of adding the at least one expected datapoint that is missing from the training dataset to the transformed training dataset; changing a first data structure of the first label to a second data structure with which the machine learning model is compatible; or updating a second label associated with the second datapoint to correspond to a third label associated with the counterpart expected datapoint. The processor is further configured to output the transformed training dataset.

### Mitigating Biases During Training of a Machine Learning Model

In some embodiments, a system for mitigating biases during training of a machine learning model comprises a memory operably coupled to a processor. The memory is configured to store a machine learning model and a training dataset, wherein the training dataset comprises a set of datapoints. The processor is configured to train the machine learning model using the training dataset. In some embodiments, training the machine learning model using the training dataset comprises inputting a first datapoint from among the set of datapoints to the machine learning model; receiving a first output from the machine learning model, wherein the first output is a prediction of the machine learning model with respect to a first label associated with the first datapoint; inputting a second datapoint from among the set of datapoints to the machine learning model; and receiving a second output from the machine learning model, wherein the second output is a prediction of the machine learning model with respect to the first label associated with the second datapoint. The processor is further configured to compare the first output with the second output. The processor is further configured to determine that the first output does not correspond with the second output. The processor is further configured to determine that the machine learning model is biased in response to determining that the first output does not correspond with the second output. The processor is further configured to update the machine learning model by updating one or more parameters of a neural network associated with the machine learning model in response to determining that the machine learning model is biased. The one or more parameters comprise a weight value or a bias value. The processor is further configured to output the updated machine learning model.

### Mitigating Biases in a Machine Learning Model During Post-Processing

In some embodiments, a system for mitigating biases during training of a machine learning model comprises a memory operably coupled to a processor. The memory is configured to store a machine learning model and a training dataset, wherein the training dataset comprises a set of datapoints. The processor is configured to access the machine learning model, wherein the machine learning model is trained using the training dataset. The processor is further configured to test the machine learning model. In some embodiments, testing the machine learning model comprises inputting a set of real-world input data to the machine learning model; receiving a set of outputs from the machine learning model; and evaluating at least one of the set of outputs against a respective expected output, wherein the respective expected output is determined based at least in part upon a historical record associated with the set of real-world input data. The processor is further configured to determine that more than a threshold number of outputs from among the set of outputs differ from respective expected outputs. The processor is further configured to determine that the machine learning model is biased in response determining that more than the threshold number of outputs from among the set of outputs differ from respective expected outputs. The processor is further configured to perform one or more corrective actions in response to determining that the machine learning model is biased. The one or more corrective actions comprise adjusting one or more parameters associated with the machine learning model. The one or more parameters comprise a weight value or a bias value.

Some embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to detect and mitigate biases in various stages of a machine learning model.

FIG. 2 illustrates an example operational flow of the system of FIG. 1;

FIG. 3 illustrates an example flowchart of a method to detect and mitigate biases in various stages of a machine learning model;

FIG. 4 illustrates an example operational flow of the system of FIG. 1 for mitigating biases during the training of the machine learning model;

FIG. 5 illustrates an example flowchart of a method for mitigating biases during the training of a machine learning model;

FIG. 6 illustrates an example operational flow of the system of FIG. 1 for mitigating biases during testing of a machine learning model; and

FIG. 7 illustrates an example flowchart of a method for mitigating biases during the testing of the machine learning model.

### DETAILED DESCRIPTION

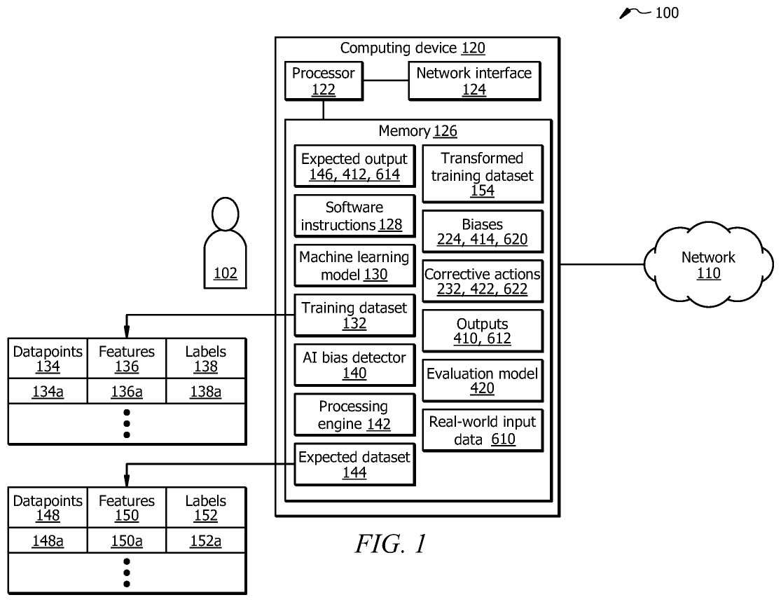

As described above, previous technologies fail to provide efficient and reliable solutions to detect and mitigate biases in various stages of a machine learning model. Embodiments of the present disclosure and its advantages may be understood by referring to FIGS. 1 through 7. FIGS. 1 through 7 are used to describe systems and methods to detect and mitigate biases in various stages of a machine learning model, according to some embodiments.

### System Overview

FIG. 1 illustrates an embodiment of a system 100 that is generally configured to detect and mitigate biases that may occur in pre-processing, in-processing, and post-processing stages associated with a training dataset and a machine learning model. In some embodiments, the system 100 comprises a computing device 120 communicatively coupled with other devices via a network 110. The network 110 enables communication between the computing device 120 and other devices, such as servers, desktop computers, mobile phones, laptops, and the like. The computing device 120 may be associated with a user 102 and serve to detect and mitigate biases. In other embodiments, system 100 may include other elements instead of, or in addition to, those listed above.

In general, the system 100 provides technical improvements to the current bias detection and mitigation techniques. In current systems, artificial intelligence (AI) biases are anomalies in the output of the machine learning models. For example, AI biases may occur due to prejudiced assumptions made during the model development process and/or in the process of data sampling and labeling for generating the training dataset. In some cases, the biases may occur when a machine learning model produces results that are systematically biased due to erroneous assumptions in the machine learning process. A biased training dataset may cause inconsistencies and does not represent the machine learning model's accuracy and performance accurately, and therefore, leads to skewed outputs, systematic prejudice, and low prediction accuracy. Typically, a biased training dataset and/or a biased machine learning model skews the results of the machine learning model in favor of or against a particular set of datapoints and the error may occur between the average of model prediction and the ground truth (i.e., expected output known to be true).

The disclosed system 100 is configured to provide a solution to these and other technical problems raised by biased datasets and biased machine learning algorithms. In some embodiments, the disclosed system 100 is configured to detect at which stage of the life cycle of a machine learning model a bias is detected. For example, system 100 determines whether a bias is detected before the training process of the machine learning model (i.e., during pre-processing), during the training process of the machine learning model (i.e., during in-processing), or during the testing stage of the machine learning model (i.e., post-processing). In response to detecting a bias, the system 100 is configured to mitigate the bias. For example, a bias may be due to the under-sampling of data and/or over-sampling of data in the training dataset, personal views and experiences of developers of the machine learning model that have affected the development of the machine learning model, among others.

The system 100 is configured to detect whether there is any bias in the dataset before the training of the machine learning model (i.e., during pre-processing) by comparing the dataset with the expected dataset. If any anomaly or inconsistency between each datapoint of the dataset and the counterpart datapoint of the expected dataset is detected, this may be an indication of a bias in the training dataset.

In the pre-processing, the bias may be caused by and/or associated with a missing datapoint from the training dataset (that is found in the expected dataset), inconsistent labels of two or more corresponding datapoints, missing features from a datapoint, and incompatible label/datapoint with the machine learning model, among other inconsistencies. In response, the system 100 may add the missing datapoints to the training dataset, change the inconsistent labels to an updated label that is consistent across corresponding datapoints, add a feature data (or feature vector) to a datapoint that is missing the feature data (or the feature vector), and change the data structure of an incompatible label/datapoint to another data structure that is compatible with the machine learning model. In this manner, the system 100 transforms the training dataset to reduce or otherwise minimize the biases in the training dataset.

The system 100 is configured to detect whether there is any bias in the dataset and/or the machine learning model during the training of the machine learning model (i.e., during in-processing) by comparing the output of the machine learning model with the expected output. For example, if the system 100 determines that the output of the machine learning model does not correspond to the expected output, it may be an indication of a bias in the training dataset and/or the machine learning model. For example, if a similar output is generated for multiple different input data for several iterations, it may be an indication of a bias in the training dataset and/or the machine learning model. In response to detecting a bias, the system 100 identifies the datapoints that were caused by the bias, and updates their labels and/or features to mitigate the bias. For example, the system 100 may change the label and/or features of a datapoint to correspond to a label and/or features of a counterpart expected datapoint, respectively.

For example, the system 100 may access the historical records of a datapoint that is identified to be associated with a bias (e.g., missing, irrelevant, incompatible, or incorrect label and/or feature) and update the label and/or feature of the datapoint based on the historical records such that the updated label and/or feature correspond to that indicated in the historical record. In this manner, the system 100 may remedy the detected biases and generate an updated training dataset and machine learning model with reduced (or minimized) biases.

During the post-processing, the system 100 deploys the trained machine learning model and obtains output from the machine learning model. The output of the machine learning model 130 may be the model's prediction based on a given input. The system 100 may determine whether the output is biased. For example, the system 100 may determine the accuracy score of the machine learning model 130. If, for example, the accuracy score of the machine learning model 130 is less than a threshold score (e.g., less than 30%, 20%, etc.), it may be an indication of bias in the machine learning model 130 and/or the training dataset 132. Thus, in one example, If the machine learning model 130's performance does not align with the expected accuracy threshold, the system 100 may flag this discrepancy as a potential bias.

As another example, the system 100 may compare the outputs of the machine learning model 130 with real-world data and associated expected outcomes. If the predicted output of the machine learning model 130 deviates from the real-world data patterns and associated expected outcome, this discrepancy is flagged as a potential bias. Upon detecting such a bias, the system 100 may take corrective actions. In this process, the system may assess the machine learning model 130's output in detail to identify specific areas where the predictions do not correspond to the expected outcome. For example, the discrepancy may include missing features, incorrect labels, or other anomalies that suggest a bias. In response to identifying the anomalous areas in the output, the system 100 may adjust the machine learning model 130 by recalibrating (e.g., changing) the labels of input data, recalibrating (e.g., changing) the labels of the output data, and adding any missing labels and features that were identified during the comparison stage.

In addition to these corrections, the system 100 iterates through a feedback loop to continually adjust the machine learning model 130 and/or the training dataset 132 by evaluating and updating the labels 138 and features 136 of the datapoints 134 within the training dataset 132 and the output of the machine learning model 130 (if needed). This loop includes reassessing the machine learning model 130's predictions against the expected output data to determine whether all features 136 and labels 138 are accurately represented and whether the predicted outputs correspond to the expected output. The post-processing correction enables the machine learning model 130 to adapt over time, which, in turn, increases the predictive accuracy and fairness of the model. If the accuracy score of the machine learning model is less than the threshold score, the feedback and adjustment cycle may continue until the machine learning model 130 achieves at least the threshold accuracy score or higher, which may indicate that the biases are reduced or minimized. Thus, the system 100 facilitates that the machine learning model 130 is dynamic and is able to self-correct in response to ongoing input and performance evaluation.

In this manner, in some embodiments, the system 100 is configured to detect and mitigate biases in pre-processing, in-processing, and post-processing stages of a machine learning model. Thus, the system 100 improves the bias detection and mitigation techniques by implementing a multi-stage framework that addresses potential biases at each phase of a machine learning model 130's development, testing, and deployment. With the reduced biases in the training dataset 132 and the machine learning model 130, the performance and accuracy of the machine learning model 130 is increased.

In some embodiments, the system 100 is configured to conserve the processing and memory resources of the computing device 120. For example, the system 100 identifies at which stage of the life cycle of the machine learning model a bias is detected and zones in to investigate that particular stage. Thus, the computing device 120 may allocate processing and memory resources to specifically address the detected bias at its source rather than expending processing and memory resources across all stages of the machine learning lifecycle.

For example, if a bias is detected during the pre-processing stage, the system 100 allocates its processing and memory resources to analyze and rectify the data at this stage. Thus, the system 100 may reduce the probability of the propagation of biased data through subsequent stages (namely training and testing stages). Therefore, the system 100 implements a targeted correction technique to avoid unnecessary reprocessing of data in later stages, which would require additional computational power.

Similarly, if a bias is detected during the in-processing (training) stage, the system 100 may adjust the training process, such as by modifying the labels 138 and features 136 of datapoints 134 in the training dataset 132, and parameters 424 of the neural network of the machine learning model 130 (e.g., weights and bias values), to reduce the inadvertently injected bias. Therefore, the system 100 obviates the need for comprehensive retraining or post-hoc corrections that are more resource intensive.

In the post-processing stage, if the system 100 detects a bias, the system 100 applies targeted adjustments to the machine learning model 130's output or its decision-making criteria to correspond to expected output associated with real-world data. This, in turn, leads to spending less processing and memory resources that would otherwise be spent on reevaluating and reconstructing the machine learning model.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may be configured to support any suitable type of communication protocol as would be appreciated by one of ordinary skills in the art.

### Example Computing Device

Computing device 120 may generally be any device that is configured to process data and interact with users 102. Examples of the computing device 120 include, but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, a kiosk such as an automated teller machine (ATM), or any other suitable type of device. The computing device 120 may include a user interface, such as a display, a microphone, a camera, a keypad, or other appropriate terminal equipment usable by user 102.

The computing device 120 may include a hardware processor, memory, and/or circuitry configured to perform any of the functions or actions of the computing device 120 described herein. For example, the computing device 120 includes a processor 122 in signal communication with a network interface 124, and a memory 126. The memory 126 stores software instructions 128 that when executed by the processor 122 cause the processor 122 to perform one or more operations of the computing device 120 described herein.

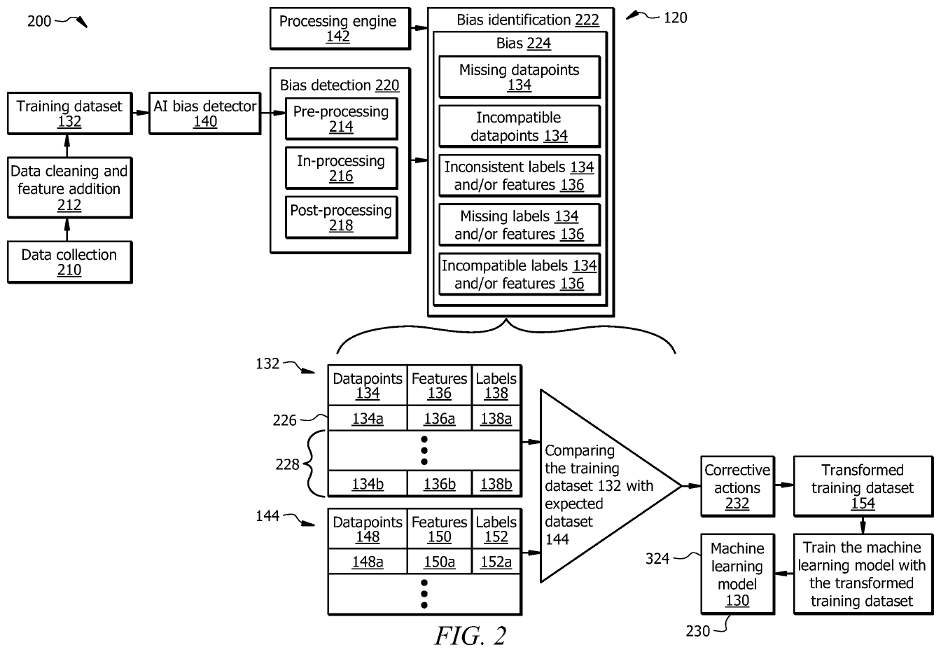

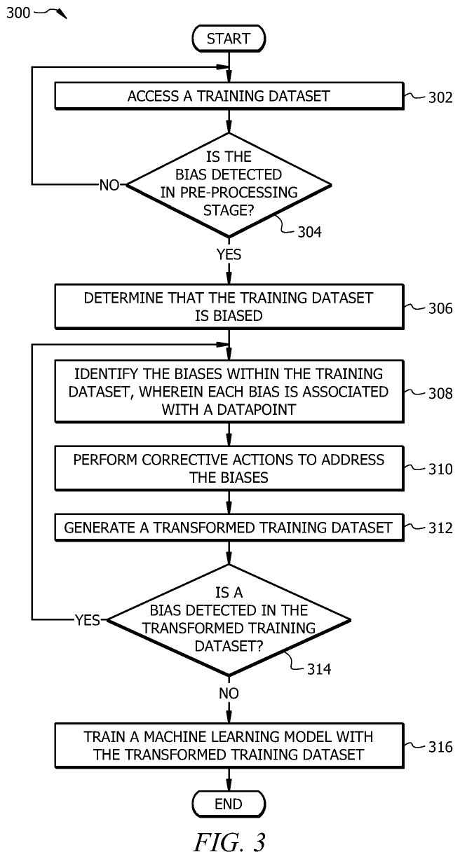

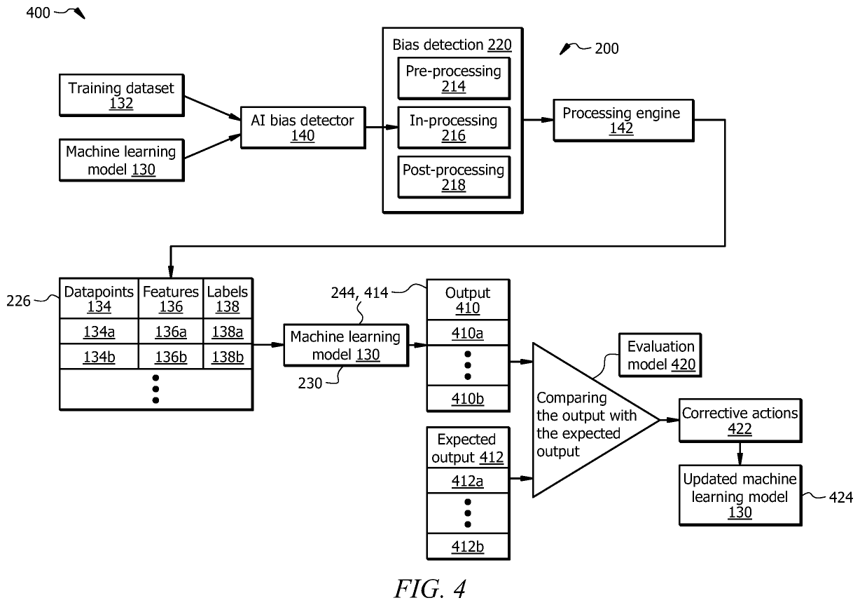

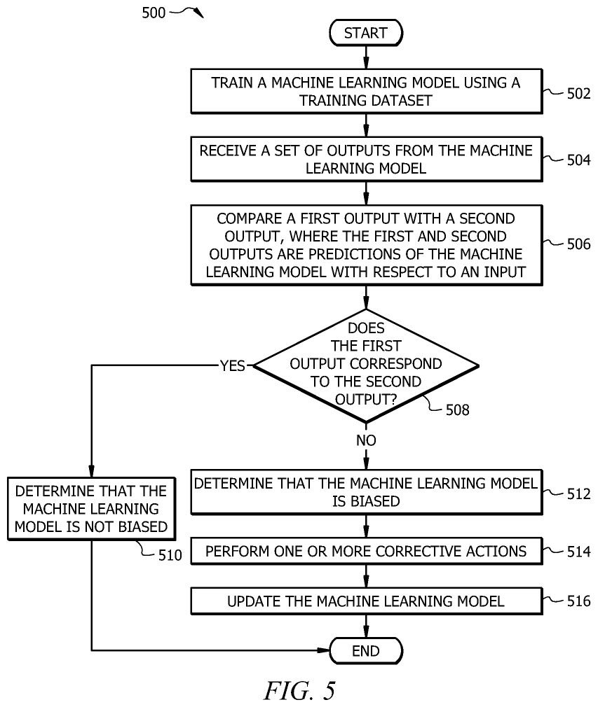

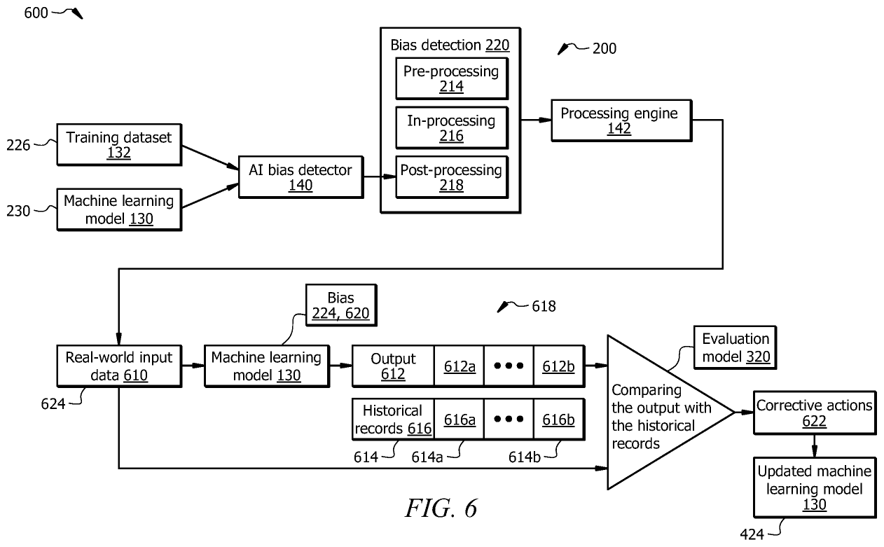

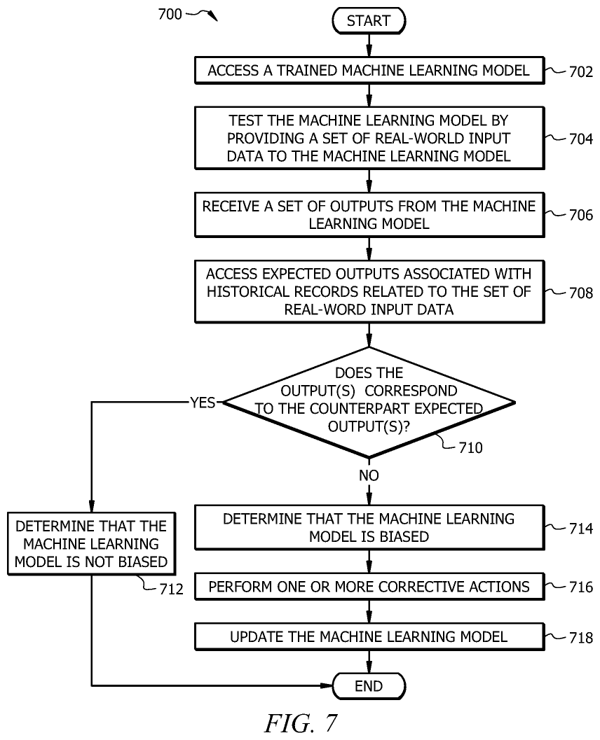

Processor 122 comprises one or more processors. The processor 122 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 122 may be a programmable logic device, a microcontroller, a microprocessor, or any suitable number and combination of the preceding. The one or more processors are configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations. The processor 122 may register the supply operands to the ALU and store the results of ALU operations. The processor 122 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 128) to perform the operations of the computing device 120 described herein. In this way, processor 122 may be a special-purpose computer designed to implement the functions disclosed herein. In an embodiment, the processor 122 is implemented using logic units, FPGAS, ASICs, DSPs, or any other suitable hardware. The processor 122 is configured to operate as described in FIGS. 1-7. For example, the processor 122 may be configured to perform one or more operations of the operational flow 200 as described in FIG. 2, one or more operations of the method 300 as described in FIG. 3, one or more operations of the operational flow 400 as described in FIG. 4, one or more operations of the method 500 as described in FIG. 5, one or more operations of the operational flow 600 as described in FIG. 6, one or more operations of the method 700 as described in FIG. 7.

Network interface 124 is configured to enable wired and/or wireless communications. The network interface 124 may be configured to communicate data between the computing device 120 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol.

Memory 126 may be a non-transitory computer-readable medium. The memory 126 may be volatile or non-volatile and may comprise read-only memory (ROM), random-access memory (RAM), ternary content-addressable memory (TCAM), dynamic random-access memory (DRAM), and/or static random-access memory (SRAM). The memory 126 may include one or more of a local database, a cloud database, a network-attached storage (NAS), etc. The memory 126 comprises one or more disks, tape drives, or solid-state drives, and may be used as an over-flow data storage device, to store programs when such programs are selected for execution, and to store instructions and data that are read during program execution. The memory 126 may store any of the information described in FIGS. 1-4 along with any other data, instructions, logic, rules, or code operable to implement the function(s) described herein when executed by processor 122. For example, the memory 126 may store software instructions 128, machine learning model 130, training dataset 132, expected dataset 144, AI bias detector 140, expected output 146, 412, and 614, biases 224, 414, and 620, real-world input data 610, evaluation model 420, transformed training dataset 154, corrective actions 232, 422, and 622, outputs 410 and 612, processing engine 142, and/or any other data or instructions. The software instructions 128 may comprise any suitable set of instructions, logic, rules, or code operable to execute the processor 122 and perform the functions described herein, such as some or all of those described in FIGS. 1-4.

The machine learning model 130 may be implemented by the computing device 120 executing the software instructions 128, and is generally configured to predict output based on a given training dataset 132. In some embodiments, the machine learning model 130 may comprise a support vector machine, neural network, random forest, k-means clustering, facial recognition algorithm, etc. The machine learning model 130 may be implemented by a plurality of neural network (NN) layers, convolutional NN (CNN) layers, Long-Short-Term-Memory (LSTM) layers, Bi-directional LSTM layers, recurrent NN (RNN) layers, and the like. The machine learning model 130 may be configured for any use cases, such as user classification (to predict to which class, each user belongs), object detection (to detect objects in images), pattern prediction, text detection (natural language processing), text summarization, among others.

In some embodiments, the machine learning model 130 may be trained to perform its operation based on the training dataset 132. The training dataset 132 may include a set of datapoints 134, where each datapoint 134 is associated with a set of features 136 and label 138. For example, the datapoint 134a is associated with the set of features 136a and label 138a. The set of features 136 may be represented by a feature vector and indicate a set of attributes of the datapoint 134, depending on the use case of the training dataset 132. For example, in the case of user classification, the features 136a of the datapoint 132 may include birth year, salary, income, physical attributes, address, among other attributes.

The label 138 of a datapoint 134 may indicate a result that corresponds to the features 136 of that datapoint 132. In example of user classification related to visitors of a website or a place, the label 138a-b may represent the category or class that the user belongs to, such as “new user,” “returning user,” “frequent user” categories, or any other category. The labels 138 in the training dataset 132 serve as a guide for the machine learning model 130 to learn from the data to make predictions about new, unseen datapoints 134 based on the learned patterns and associations between the features 136 and label 138 of each datapoint 134 from the training dataset 132.

The AI bias detector 140 may be implemented by the processor 122 executing the software instructions 128 and is generally configured to detect at which stage of the life cycle of the machine learning model 130 a bias is detected. For example, the bias detector 140 determines whether an anomaly (i.e., bias) is detected in the training dataset 132 before it is used to train the machine learning model 130 (pre-processing), during the training of the machine learning model 130 (in-processing), or during the testing of the machine learning model 130 (post-processing). In response to detecting a bias in a given stage, the bias detector 140 routes instructions to a respective processing engine to detect and mitigate the bias. In some examples, the bias may include, be associated with, and/or caused by a missing label 138 of a datapoint 134, missing datapoint 134 in the training dataset 132 compared to the expected dataset 144, missing feature 136 of a datapoint 134 compared to the expected dataset 144, etc. In some examples, the bias may include, be associated with, and/or caused by an inconsistency between the output of the machine learning model 130 and the expected output 146. In some embodiments, the bias detector 140 may be configured to detect the type of bias.

The processing engine 142 may be implemented by the processor 122 executing the software instructions 128. The processing engine 142 may be configured to detect and mitigate biases in the training dataset 132 during the pre-processing (i.e., before the training dataset 132 is used for training of the machine learning model 130), during the in-processing (i.e., during the training of the machine learning model 130), or during the post-processing (during the testing of the machine learning model 130. For example, the processing engine 142 may be configured to identify the potential biases in the training dataset 132, generate customized datapoints 134 that are determined to be missing from the training dataset 132, add and/or update features 136 and labels 138 that are determined to be missing or anomalous, etc.

The expected dataset 144 may include a set of expected datapoints 148 that represent a comprehensive data sampling and collection, where each datapoint 148 is associated with respective features 150 and label 152. For example, the datapoint 148a is associated with the features 150a and label 152a. The operations to mitigate the biases 224 may be referred to as corrective actions 232.

The evaluation model 420 may be implemented by the processor 122 executing the software instructions 128, and is generally configured to evaluate the outputs 410 and 612 of the machine learning model 130. In some embodiments, the evaluation model 420 may comprise a support vector machine, neural network, random forest, k-means clustering, facial recognition algorithm, etc. The evaluation model 420 may be implemented by a plurality of neural network layers, CNN layers, LSTM layers, Bi-directional LSTM layers, RNN layers, and the like.

### Example Operational Flow for Mitigating Biases in Training Dataset During Pre-Processing

FIG. 2 illustrates an example operational flow 200 of system 100 (see FIG. 1) for mitigating biases in training dataset 132 during pre-processing. In operation, at data collection 210, the training dataset 132 may be collected from various data sources, such as online data, offline data, etc. The content of the training dataset 132 may vary depending on the use case that the training data 132 may be intended to be used, such as user classification, prediction, etc., similar to that described in FIG. 1.

In data cleaning and feature addition 212, the training dataset 132 may undergo a process to improve its quality before being used by the machine learning model 130. For example, during data cleaning, the user 102 may identify and remove erroneous datapoints 134, and inconsistencies among the datapoints 134 of the training dataset 132, such as removing outliers, etc. In another example, during feature addition, features 136 are extracted from each datapoint 134 and added to the respective datapoint 134. In another example, labels 138 may be identified and added to respective datapoints 134.

The generated training dataset 132 may be forwarded to the bias detector 140 for evaluation. During the bias detection 220, the bias detector 140 may determine whether the training dataset 132 includes any biases (i.e., whether the training dataset 132 is biased). In some embodiments, the bias detector 140 may determine at which stage of life cycle of the machine learning model 130 the bias is detected. If the bias detector 140 determines that the training dataset 132 has not yet been used to train the machine learning model 130, the bias detector 140 may forward the training dataset 132 to the processing engine 142 to identify and mitigate the detected biases. In another example, if the bias detector 140 determines that the training dataset 132 has not yet been used to train the machine learning model 14, it may determine that the machine learning model 130 is in the pre-processing 214.

### Identifying the Biases in the Training Dataset

The processing engine 142 may receive the training dataset 132 for evaluation. The processing engine 142 may determine whether the training dataset 132 is biased (i.e., includes or is associated with biases 224). In some examples, the biases 224 may include missing datapoints 134, incompatible datapoints 134, inconsistent labels 138 and/or features 136, missing labels 138 and/or features 136, and incompatible labels 138 and/or features 136, among others.

To this end, in some embodiments, the processing engine 142 may compare each datapoint 134 of the training dataset 132 with each datapoint 148 of the expected dataset 144. The processing engine 142 may identify which expected datapoint 148 is the counterpart of a given datapoint 134 by analyzing the similarities and differences in the features 136 and 150, and labels 138 and 152. For example, if more than a threshold number of features 136a corresponds to the counterpart features 150a, and/or if the label 138a corresponds to the label 152a, the processing engine 142 may determine that the expected datapoint 148a is the counterpart of the datapoint 134a. Similar operations may be performed for other datapoints 134.

In some embodiments, the processing engine 142 may determine that the training dataset 132 is biased based on determining that any of the biases 224 has been found in relation to one or more datapoints 134 of the training dataset 132. For example, the processing engine 142 may determine that the training dataset 132 is biased based on determining that a datapoint 134 is missing from the training dataset 132 based on the comparison between the training dataset 132 and the expected dataset 144 and determining that a counterpart datapoint 148 (that is determined to be the counterpart of the missing datapoint 134) is present in the expected dataset 144.

In some embodiments, the processing engine 142 may determine that the training dataset 132 is biased based on determining that a datapoint 134 is incompatible with the machine learning model 130 and/or other datapoints 134. For example, if the datapoint 134a is determined to be associated with a first data structure 226 that is incompatible with the data structures 228 of other datapoints 134 and/or the machine learning model 130 does not accept the data structure 226, it may be determined that the datapoint 134a is a source of bias 224. For example, each of data structures 226, 228, and 230 may be in JavaScript object notation (Json) format, extendible markup language (xml) format, among other formats. In another example, each of data structures 226, 228, and 230 may be an array, linked list, graph, stack, queue, tree, hash table, heap, dictionary, etc. In another example, each of data structures 226, 228, and 230 may be specific to a programming language, such C, C++, etc.

In some embodiments, the processing engine 142 may determine that the training dataset 132 is biased based on determining that a label 138 and/or feature 136 of a datapoint 134 is incompatible with the machine learning model 130 and/or other datapoints 134. For example, if the label 138a and/or feature 136a is associated with the data structure 226 that is incompatible with the data structures 228 of other datapoints 134 and/or the machine learning model 130 does not accept the data structure 226, it may be determined that the label 138a and/or feature 136a is a source of bias 224, respectively. In response, the processing engine 142 may update (e.g., change) the data structure 226 associated with the label 138a and/or feature 136a to be the data structure 230 which is determined to be accepted by the machine learning model 130.

In some embodiments, the processing engine 142 may determine that the training dataset 132 is biased based on determining a label 138 is a datapoint 134 is associated with an incorrect label 138 compared to the counterpart expected datapoint 148. For example, the processing engine 142 may identify that the counterpart datapoint 148a is the counterpart of the datapoint 134a and compare the label 138a associated with the datapoint 134a with the label 152a associated with the counterpart expected datapoint 148a.

The processing engine 142 may implement any neural network machine learning algorithm for comparison, such as natural language processing, etc. If the processing engine 142 determines that the label 138a does not correspond to label 152a, the processing engine 142 may determine that the label 138a is incorrect. In response, the processing engine 142 may update and change the label 138a to label 152a. Similarly, the processing engine 142 may perform a similar operation for inconsistent features 136, 150 of corresponding datapoints 134, 148. For example, the processing engine 142 may determine that the expected datapoint 148a is the counterpart of the datapoint 134a and compare each feature 136a with the counterpart feature 150a. If the processing engine 142 determines that more than a threshold number of features 136a do not correspond to the counterpart features 150a, the processing engine 142 may determine that at least the threshold number of features 136a is inconsistent, anomalous, i.e., the source of a bias 224. In response, the processing engine 142 may update and change the inconsistent features 136a to be the counterpart features 150a.

In some embodiments, the processing engine 142 may determine that the training dataset 132 is biased based on determining that a label 138 and/or feature 136 is missing from a datapoint 134. For example, if the processing engine 142 determines that the datapoint 134a is not associated with a feature 136a and/or label 138a, the processing engine 142 may determine that the datapoint 134a is missing the feature 136a and/or label 138a. In response, the processing engine 142 may identify the counterpart expected datapoint 148a associated with the datapoint 134a and add the label 152a and features 150a to be associated with the datapoint 134a.

In some embodiments, the processing engine 142 may determine that the training dataset 132 is biased based on determining that the labels 138 and/or features 136 of at least two corresponding datapoints 134 are inconsistent with each other, respectively. For example, assume that the datapoints 134a and 134b represent users with the same job, however, the label 138a and/or feature 136a of the first datapoint 134a indicates that the first user has a first job, while the label 138b and/or feature 136b of the second datapoint 134b indicates that the second user has a second job that is different than the first job. In this example, the labels 138a and 138b and/or features 136a and 136b are not consistent with each other. Thus, the processing engine 142 may update at least one of the labels 138a and 138b to correspond to each other, for example, based on the label 152a of the counterpart expected datapoint 148a of the first datapoint 134a, such that the labels 138a and 138b may be updated to be the label 152a. Likewise, the processing engine 142 may update at least one of the features 136a and 136b to correspond to each other, for example, to be the features 150a of the counterpart expected datapoint 148a.

### Transforming the Training Dataset

In response to detecting the biases 224 in the training dataset 132, the processing engine 142 may mitigate the biases 224 by generating a transformed training dataset 154 in which the biases 224 are addressed and reduced. For example, if the processing engine 142 identifies missing datapoints 134 or underrepresented categories within the training dataset 132, the processing engine 142 may generate additional datapoints 134 and/or modify existing ones to fill these gaps. This process may include synthetic data generation or oversampling of underrepresented groups to enhance the diversity in the training dataset 132. Thus, the processing engine 142 may add the expected datapoints 148 that are missing from the training dataset 132 to the transformed dataset 154. In another example, for datapoints 134 with incorrect labels 138 and/or features 136, the processing engine 142 updates these elements to align (correspond) with their correct counterparts identified in the expected dataset 144.

In another example, if certain datapoints 134 are incompatible with each other and/or with the machine learning model 130 due to differing data structures 226, 228, and 230, the processing engine 142 updates or changes the data structures 226, 228, and 230 across the transformed dataset 132 such that they are compatible with each other and the machine learning model 130.

Similarly, if certain labels 138 are incompatible with other labels 138 and/or with the machine learning model 130 due to differing data structures 226, 228, and 230, the processing engine 142 updates or changes the data structures 226, 228, and 230 to the data structure 230 to which the machine learning model 130 is compatible. In some embodiments, in case of differing data structures 226, 228, and 230, the processing engine 142 may update (e.g., change) the data structures 226, 228, and 230 to the data structure associated with the related elements of the expected dataset 144.

The processing engine 142 may facilitate that for similar (corresponding) datapoints 134, the features 136 and labels 138 are consistent with each other, respectively. For example, in response to determining that the datapoints 134a and 134b are corresponding to each other and the label 138b does not correspond to the label 138a, the processing engine 142 may update the label 138b of the second datapoint 134a to the first label 138a. In another example, in response to determining that the datapoints 134a and 134b are corresponding to each other and the label 138b does not correspond to the label 138a, the processing engine 142 may update the label 138b of the second datapoint 134a to the label 152a that is determined to be the counterpart expected datapoint 148a associated with the datapoint 134b and/or 134a.

In response to generating the transformed training dataset 154, the processing engine 142 may reassess the transformed training dataset 154 for any residual bias 224 and take corrective actions 232 similar to that described above. The processing engine 142 may iteratively assess the transformed training dataset 154 in a loop until no bias 224 is found. In response, the processing engine 142 may train the machine learning model 130 with the transformed training dataset 154.

If the processing engine 142 determines that a new datapoint 134 is added to the training dataset 132, the processing engine 142 may evaluate the new datapoint 134 and determine whether it is associated with or includes any bias 224. For example, the processing engine 142 may identify an expected datapoint 148 that is the counterpart of the new datapoint 134 and compare the new datapoint 134 with the expected datapoint 148. In response, the processing engine 142 may determine whether there is an inconsistency between the new datapoint 134, its features 136, and label 138 with the expected datapoint 148, its features 150, and labels 152, respectively.

The processing engine 142 may determine whether the label 138 of the new datapoint 134 corresponds to the label 152 of the counterpart expected datapoint 148. The processing engine 142 may determine whether the data structure of the label 138 of the new datapoint 134 (or the data structure of features 136 of the datapoint 134) is compatible with the data structure 230 to which the machine learning model 130 is compatible. The processing engine 142 may change the data structure of the label 138, feature 136, and/or the new datapoint 134 to be the data structure 230 if they are different.

### Example Method for Mitigating Biases in Training Dataset During Pre-Processing

FIG. 3 illustrates an example flowchart of a method 300 for mitigating biases in training datasets during pre-processing, according to some embodiments. Modifications, additions, or omissions may be made to method 300. Method 300 may include more, fewer, or other operations. For example, operations may be performed in parallel or in any suitable order. While at times it is discussed that the system 100, computing devices 120, processing engine 142, or components of any of thereof perform some operations, any suitable system or components of the system may perform one or more operations of the method 300. For example, one or more operations of method 300 may be implemented, at least in part, in the form of software instructions 128 of FIG. 1, stored on a tangible non-transitory machine-readable medium (e.g., memory 126 of FIG. 1) that when run by one or more processors (e.g., processor 122 of FIG. 1) may cause the one or more processors to perform operations 302-316.

At operation 302, the processing engine 142 accesses a training dataset 132. The training dataset 132 may include the datapoints 134, each associated with a label 138 and features 136. At operation 304, the processing engine 142 determines whether a bias 224 is detected during the pre-processing 214. If it is determined that the bias 224 is detected during the pre-processing 214, the method 300 proceeds to operation 306. Otherwise, the processing engine 142 may return to operation 302 and wait for a training dataset 132 that has not been used to train a machine learning model 130.

At operation 306, the processing engine 142 determines that the training dataset 132 is biased. For example, the processing engine 142 may determine that one or more biases 224 are found in the training dataset 132, similar to that described in FIG. 2. At operation 308, the processing engine 142 identifies the biases 224, where each bias 224 may be associated with a datapoint 234 within the training dataset 132, similar to that described in FIG. 2.

At operation 310, the processing engine 142 may perform corrective actions 232 to address the biases 224. The examples of the corrective actions 232 are described in FIG. 2. At operation 312, the processing engine 142 generates a transformed training dataset 154. The transformed training dataset 154 may be the updated training dataset 132 after the biases 224 are addressed and mitigated.

At operation 314, the processing engine 142 determines whether a bias 224 is detected in the transformed training dataset 154. In other words, the processing engine 142 may continuously assess and reevaluate the transformed training dataset 154 until no bias 224 is detected. If it is determined that no bias 224 is detected in the transformed dataset 154, the method 300 may proceed to operation 316. Otherwise, the method 300 may return to operation 308 where the transformed dataset 154 is reevaluated and biases 224 are addressed and mitigated. At operation 316, the processing engine 142 trains the machine learning model 130 with the transformed training dataset 154 for the intended use cases.

### Example Operational Flow for Mitigating Biases During the Training of a Machine Learning Model

FIG. 4 illustrates an example operational flow 400 of the system 100 (see FIG. 1) for mitigating biases during the training of the machine learning model 130, according to some embodiments. In operation, the operational flow 400 may begin when the training of the machine learning model 130 is initiated. For example, the bias detection and mitigation of the operational flow 400 may occur when the machine learning model 130 is being trained using the training dataset 132.

The processing engine 142 of the computing device 120 may feed the training dataset 132 and the machine learning model 130 to the AI bias detector 140. During the bias detection 220, the bias detector 140 may determine at which stage of the life cycle of the machine learning model 130, it receives the training dataset 132 and the machine learning model 130. In the example of FIG. 4, the bias detector 140 may determine that the data is received during the in-processing 216, i.e., during the training of the machine learning model 130. In response, the bias detector 140 may identify the type of detected biases.

The bias detector 140 may forward the training dataset 132 and the machine learning model 130 to the processing engine 142 for evaluation. In some cases, the processing engine 142 may evaluate the training dataset 132 and the machine learning model 130 to determine whether any of them include or are associated with a bias. For example, the processing engine 142 may detect and mitigate any of the biases 224 associated with the training dataset 132 and/or the machine learning model 130, similar to that described in FIG. 2.

### Training the Machine Learning Model

The processing engine 142 may train the machine learning model 130 using at least a portion of the training dataset 132. During this process, a set of datapoints 134 may be fed to the machine learning model 130 and the machine learning model 130 is asked to learn the relationship between each datapoint 134 and its label 138. For example, the datapoint 134a and label 138a is fed to the machine learning model 130 and the machine learning model 130 may extract the set of features 136a from the datapoint 134a. In some examples, the features 136a may or may not be provided to the machine learning model 130.

Based on the features 136a, the machine learning model 130 may determine the identity of the datapoint 134a and associate it to the label 138a. This may occur in a first iteration of determining parameters of the neural network of the machine learning model 130, where the parameters include bias and weight values. In the next iteration, the datapoint 134a may be fed to the machine learning model 130 without the label 138a and the machine learning model 130 may be asked to predict the label of the datapoint 134a. In response, the machine learning model 130 may provide the output 410a, where the output 410a may be the prediction of the machine learning model 130 with respect to the label 138a of the datapoint 134a.

Thus, upon extracting or receiving the features 136a, the machine learning model 130 employs the features 136a to ascertain the identity of datapoint 134a and maps it to label 138a. The machine learning model 130 may perform the identification and mapping through an iterative process, where the parameters of the neural network of the machine learning model 130 are adjusted. Subsequently, in a successive iteration, the datapoint 134a may be input into the machine learning model 130 without the label 138a, and the machine learning model 130 is then tasked to predict the label. The output 410a generated by the machine learning model 130 represents the prediction of the machine learning model 130 with respect to the label 138a for the datapoint 134a. Similar operation may occur for the other datapoints 134.

For example, the datapoint 134b may be fed to the machine learning model 130 without the label 138b and the machine learning model 130 may be asked to predict the label associated with the datapoint 134b. In response, the machine learning model 130 may extract the set of features 136b from the datapoint 134b and determine the association and relationship between the datapoint 134b and the features 136b. In response, the machine learning model 130 may provide the output 410b, where the output 410b may be the prediction of the machine learning model 130 with respect to the label 138b of the datapoint 134b. Likewise, the machine learning model 130 may provide outputs 410 for other datapoints 134.

### Evaluating the Output of the Machine Learning Model

The processing engine 142 may evaluate the output 410 of the machine learning model 130. For example, in some embodiments, the processing engine 142 may compare each output 410 with the counterpart expected output 412. For example, the processing engine 142 may compare the output 410a with its counterpart expected output 412a, and output 410b with its counterpart expected output 412b. In other words, the processing engine 142 may evaluate the output 410 against the counterpart expected output 412.

If it is determined that an output 410 does not correspond to its counterpart expected output 412, the processing engine 142 may determine that the output 410 is associated with or caused by a bias 414. To facilitate a robust evaluation of the predictions of the machine learning model 130, another machine learning model, referred to as the evaluation model 420, may be employed. The evaluation model 420 may be trained to assess the correctness of outputs 410 produced by the primary machine learning model 130. When the primary machine learning model 130 provides an output 410, the evaluation model 420 analyzes the output 410 by extracting a first set of features from the predicted output 410 (producing a first feature vector), extracting a second set of features from the counterpart predicted output 412 (producing a second feature vector), and comparing the first feature vector with the second feature vector.

If it is determined that more than a threshold number in the first feature vector corresponds to the counterpart number in the second feature vector, it may be determined that the first feature vector corresponds to the second feature vector. Otherwise, it may be determined that the first feature vector does not correspond to the second feature vector.

### Detecting Biases in the Machine Learning Model

In response to determining that the output 410 corresponds to the expected output 412, the evaluation model 420 may determine that the predicted output 410 is not associated with or caused by a bias 414. If, however, it is determined that the first feature vector does not correspond to the second feature vector, the evaluation model 420 may determine that the predicted output 410 is associated with or caused by a bias 414.

The bias 414 may refer to systematic anomalies that may skew the outputs 410 in a particular direction, which is unfairly prejudiced or partial. The bias 414 may occur due to human error, assumptions, personal experiences, and the like. For example, one source of bias 414 may be injected during the development phase of the machine learning model 130, influenced by unconscious human error. The developers may inadvertently introduce their own pre-existing beliefs and assumptions into the machine learning model 130's design, which may be reflected in the outputs 410. In another example, a bias 414 may be implicit where the developer's personal experiences, which may not be universally applicable or representative, influence the development of the machine learning model 130.

The processing engine 142 and the evaluation model 420 may identify which output 412 is a counterpart to which predicted output 410 based on the datapoint 134 that is associated with the output 410 and expected output 412. Each expected output 412 may be associated with a respective datapoint 134. For example, the expected output 412a may be associated with the datapoint 134a, and the expected output 412b may be associated with the datapoint 134b.

In some embodiments, determining that the machine learning model 130 is biased may be in response to comparing the predicted output 410a with the counterpart expected output 412a, and determining that the predicted output 410a does not correspond with the counterpart expected output 412a.

In some embodiments, determining that the machine learning model 130 is biased may be in response to inputting the set of datapoints 134 (e.g., datapoints 134a to 134b) to the machine learning model 130, receiving the set of outputs 410 (e.g., outputs 410a to 310b), comparing each output 410 with the counterpart expected output 412, and determining that more than a threshold number (e.g., more than 50%, 60%, 70%, etc.) of the outputs 410 do not correspond to the counterpart expected outputs 412.

In some embodiments, the processing engine 142 may determine that the machine learning model 130 is biased if it is determined that similar outputs 410 (e.g., negative outputs) are predicted for more than a threshold number of datapoints 134 (e.g., for more than ten, twenty, etc. datapoints 134) in several iterations.

In some embodiments, the processing engine 142 may evaluate the outputs 410 as below. For example, the processing engine 142 may evaluate the outputs 410 against each other. If for a same or similar datapoint 134, different outputs 410 are predicted, the processing engine 142 may determine that the machine learning model 130 is biased. For example, assume that the labels 138a and 138b correspond to each other. In this example, the processing engine 142 may compare the output 410a with the output 410b, e.g., via the evaluation model 420, similar to that described above by feature extraction and feature vector comparison. The processing engine 142 may determine whether the output 410a corresponds to the output 410b. If it is determined that the output 410a does not correspond to the output 410b, the processing engine 142 may determine that the machine learning model 130 is biased. Otherwise, the processing engine 142 may determine that the machine learning model 130 is not biased.

In some embodiments, the processing engine 142 may determine that the training dataset 132 is biased in response to determining that a datapoint 134 is incompatible with the machine learning model 130. For example, the processing engine 142 may determine that the datapoint 134 is associated with a first data structure 226, and the machine learning model 130 is not configured to accept the first data structure 226. In other words, the processing engine 142 may determine that the machine learning model 130 is configured to accept the second data structure 230 and that the second data structure 230 does not correspond to the first data structure 226 of the datapoint 134.

### Mitigating the Detected Biases

In response, to detecting the biases 414, the processing engine 142 may perform one or more corrective actions 422. In some examples where biases 414 include a bias 224, the corrective actions 422 may include corrective actions 232, similar to that described in FIG. 2. For example, the processing engine 142 may add, update, and/or change labels 138a and/or features 136 and retrain the machine learning model 130 using the updated training dataset 132. In some examples when a bias 414 is caused during the development of the machine learning model 130, the corrective actions 422 may include updating the machine learning model 130 by updating one or more parameters 424 of the neural network of the machine learning model 130. The parameters 424 may include bias and weight values of the neural network of the machine learning model 130. For example, backpropagation may be performed to revise the parameters 424. The processing engine 142 may determine which parameters 424 contribute to the bias 414 and update the parameters 424 to different values and retrain the machine learning model 130. This process may be based on providing different inputs to the neural network and identifying the root cause of the bias 414 (e.g., discrepancy) between the outputs 410 and counterpart expected outputs 412. In another example, the processing engine 142, using the gradient of the loss function with respect to each relevant weight and bias, may determine how much each parameter 424 should be adjusted to reduce bias 414's impact on the output 410 and adjust those parameters 424 accordingly.

In cases where the bias is due to incompatibility between a datapoint 134 and the machine learning model 130, the processing engine 142 may generate a new datapoint 134 with the data structure 230 that is compatible with the machine learning model 130. In response, the processing engine 142 may feed the new datapoint 134 to the machine learning model 130. The machine learning model 130 may determine the output 410 for the new datapoint 134, and evaluation model 320 may determine that the new output 410 is no longer anomalous, i.e., corresponds to the counterpart expected output 412, and the bias 224 is addressed and mitigated.

### Example Method for Mitigating Biases During Training of a Machine Learning Model

FIG. 5 illustrates an example flowchart of a method 500 for mitigating biases during training of a machine learning model, according to some embodiments. Modifications, additions, or omissions may be made to method 500. Method 500 may include more, fewer, or other operations. For example, operations may be performed in parallel or in any suitable order. While at times it is discussed that the system 100, computing devices 120, processing engine 142, or components of any of thereof perform some operations, any suitable system or components of the system may perform one or more operations of the method 500. For example, one or more operations of method 500 may be implemented, at least in part, in the form of software instructions 128 of FIG. 1, stored on a tangible non-transitory machine-readable medium (e.g., memory 126 of FIG. 1) that when run by one or more processors (e.g., processor 122 of FIG. 1) may cause the one or more processors to perform operations 502-516.

At operation 502, the processing engine 142 trains a machine learning model 130 using the training dataset 132, similar to that described in FIG. 4. At operation 504, the processing engine 142 receives the set of outputs 410 from the machine learning model 130.

At operation 506, the processing engine 142 compares a first output 410 with a second output 410, where the first and second outputs 410 are predictions of the machine learning model 130 with respect to the input datapoint 134, similar to that described in FIG. 4.

At operation 508, the processing engine 142 determines whether the first output 410 corresponds to the second output 410. For example, if it is determined that more than first output 410 does not correspond to the second output 410, the method 500 proceeds to operation 512. In some embodiments, if it is determined that more than a threshold number of outputs 410 do not correspond to the other outputs 412 that are predictions of the machine learning model 130 with respect to the same datapoints 134, the method 500 proceeds to operation 512. In some embodiments, if it is determined that more than a threshold number of outputs 410 do not correspond to the counterpart expected outputs 412, the method 500 proceeds to operation 512. Otherwise, the method 500 proceeds to operation 510.

At operation 510, the processing engine 142 determines that the machine learning model 130 is not biased. At operation 512, the processing engine 142 determines that the machine learning model 130 is biased, i.e., associated with the bias 224 and/or 414, similar to that described in FIG. 4. At operation 514, the processing engine 142 performs one or more corrective actions 422. At operation 516, the processing engine 142 updates the machine learning model 130 according to the corrective actions 422, similar to that described in FIG. 4.

### Operational Flow for Mitigating Biases During Testing of a Machine Learning Model

FIG. 6 illustrates an example operational flow 600 of the system 100 (see FIG. 1) for mitigating biases during the testing of a machine learning model, according to some embodiments. In operation, the operational flow 600 may begin when testing of the machine learning model 130 is initiated. The processing engine 142 may feed the machine learning model 130 to the AI bias detector 140. During the bias detection 220, the bias detector 140 may determine that machine learning model 130 is received during post-processing 218, i.e., during the testing of the machine learning model 130. In response, the bias detector 140 may identify the type of the detected biases. The bias detector 140 may forward the machine learning model 130 to the processing engine 142 for evaluation.

The processing engine 142 may test the machine learning model 130. During this process, the processing engine 142 may feed a set of real-world input data 610 (without labels) to the machine learning model 130 and instruct the machine learning model 130 to predict labels for the real-world input data 610; in other words, predict a class or identifying characteristic for each real-world input data 610. The real-world input data 160 may include user information, such as salary, address, etc., images, and documents, among others.

In response, the machine learning model 130 may provide a set of outputs 612 to the processing engine 142. Each output 612 may be a prediction of the machine learning model 130 with respect to a label of a respective real-world input data 610. For example, a label may be a classification indication of real-world input data 610, such as “approved to access a document,” “not approved to access a document,” or “belongs to group A,” “belongs to group B,” etc., where groups A and B may refer to a group of users that have a common attribute, such as approved to access a document, etc. For example, the outputs 612 may include outputs 612a and 612b.

### Evaluating the Output of the Machine Learning Model

In some embodiments, the processing engine 142, via the evaluation model 320, may evaluate the outputs 612a-b against the counterpart expected outputs 614a-b. The expected outputs 614 may be determined based on the historical records 616 associated with the real-world input data 610. For example, expected outputs 614 may be derived from historical records 616, which are past datapoints that have documented the true outcomes or labels for the real-world input data 610 and/or similar data (e.g., data with more than a threshold similarity compared to the data 610).

For example, assume the machine learning model 130 is tasked to predict whether a user should be approved to access a specific document based on their profile data. In this scenario, an expected output 614 may be a dataset where each record contains a user profile along with a true label indicating whether that user was historically approved or not approved to access the document. This dataset acts as a ground truth to evaluate the machine learning model 130's predictions. The historical records 616 may be a comprehensive collection of past instances where users attempted to access documents, and the outcomes of these attempts were recorded. In this example, the historical records 616 may include detailed logs of user requests, the decision made (approved or not approved), and any other relevant context or attributes associated with those requests. By comparing the outputs 612, such as a prediction that a particular user “belongs to group A” (users approved for document access), against the expected output 614 derived from historical records 616 (the actual status of user access approval in past cases), the accuracy and reliability of the machine learning model 130 may be assessed and validated.

### Detecting and Mitigating Biases in the Machine Learning Model

In some embodiments, the processing engine 142, e.g., via the evaluation model 320, may determine whether the machine learning model 130 is biased based on the comparison between the predicted outputs 612 and the expected outputs 614. For example, the processing engine 142, via the evaluation model 320, may determine whether more than a threshold percentage 618 of the predicted outputs 612 corresponds to the counterpart expected outputs 614, where the threshold percentage 618 maybe 70%, 80%, etc.

If it is determined that more than the threshold percentage 618 if the predicted outputs 612 correspond to the counterpart expected outputs 614, the processing engine 142 may determine that the machine learning model 130 is not biased. Otherwise, the processing engine 142 may determine that the machine learning model 130 is biased, i.e., associated with bias 224 and/or 620. In some examples, the processing engine 142 may detect and mitigate any of the biases 224 associated with the training dataset 132 and/or the machine learning model 130, similar to that described in FIG. 2. The bias 224 may be caused during the development of the machine learning model 130, such as human error, assumptions, personal experiences, and the like, associated with the developers, similar to bias 414 described in FIG. 4.

In response to determining that the machine learning model 130 is biased, the processing engine 142 may perform one or more corrective actions 622. The corrective actions 622 may be similar to corrective actions 422 described in FIG. 4. For example, the processing engine 142 may update/adjust the parameters 424 of the neural network of the machine learning model 130, similar to that described in FIG. 4.

In some embodiments, the corrective action 622 may include identifying a datapoint 134, within the training dataset 132, that is associated with an incorrect label 138 compared to the counterpart expected datapoint 148, identifying the label 152 of the counterpart expected datapoint 148, associating the datapoint 134 with the label 152, and retraining the machine learning model 130 using the revised training dataset 132 that comprises the datapoint 134 with the correct label 152.

In some embodiments, the corrective action 622 may include identifying a datapoint 134, within the training dataset 132, that is incompatible with the machine learning model 130, generating an updated datapoint 134 with a data structure 230 that is compatible with the machine learning model 130, and retraining the machine learning model 130 using the revised training dataset 132 that includes the updated datapoint 134, similar to that described in FIGS. 1-5.

In some embodiments, the corrective action 622 may include identifying a datapoint 624, within the real-world input data 610, that is incompatible with the machine learning model 130, generating an updated datapoint 624 with a data structure 230 that is compatible with the machine learning model 130, and retraining the machine learning model 130 using the revised training dataset 132 that includes the updated datapoint 624, similar to that described in FIGS. 1-5.

In some embodiments, the corrective action 622 may include determining that a label 138 associated with a datapoint 134 within the training dataset 132 is compatible with the machine learning model 130, generating an updated label 138 with the data structure 230 that is compatible with the machine learning model 130, and retraining the machine learning model 130 that includes the datapoint 134 with the updated training dataset 132.

In some embodiments, the corrective action 622 may include accessing the expected datapoints 148 that are expected to be present in the training dataset 132, comparing each of the datapoints 134 with the counterpart expected datapoint 148, determining that a datapoint 134 is missing from the training dataset 132 based on determining that the datapoint 134 is found in the expected datapoints 148, adding the datapoint 134 to the training dataset 132, and retraining the machine learning model 130 using the revised training dataset 132 that includes the datapoint 134.

In some embodiments, the corrective action 622 may include identifying a datapoint 134 that is missing a label 138, adding the label 138 to the datapoint 134, and retraining the machine learning model 130 with the revised training dataset 132 that includes the datapoint 134 associated with the label 138.

In some embodiments, the processing engine 142 may determine that the accuracy score associated with the machine learning model 130 is less than a threshold score (e.g., less than 70%, 60%, etc.) and in response, determine that the machine learning model 130 is biased.

The updated training dataset 132 described herein may correspond to the transformed training dataset 154 described in FIG. 2.

### Example Method for Mitigating Biases During Testing a Machine Learning Model

FIG. 7 illustrates an example flowchart of a method 300 for mitigating biases during testing the machine learning model 130, according to some embodiments. Modifications, additions, or omissions may be made to method 700. Method 700 may include more, fewer, or other operations. For example, operations may be performed in parallel or in any suitable order. While at times it is discussed that the system 100, computing devices 120, processing engine 142, or components of any of thereof perform some operations, any suitable system or components of the system may perform one or more operations of the method 700. For example, one or more operations of method 700 may be implemented, at least in part, in the form of software instructions 128 of FIG. 1, stored on a tangible non-transitory machine-readable medium (e.g., memory 126 of FIG. 1) that when run by one or more processors (e.g., processor 122 of FIG. 1) may cause the one or more processors to perform operations 702-718.

At operation 702, the processing engine 142 accesses a trained machine learning model 130. The machine learning model 130 is trained using the training dataset 132. At operation 704, the processing engine 142 tests the machine learning model 130 by providing a set of real-world input data 610 to the machine learning model 130, similar to that described in FIG. 6.

At operation 706, the processing engine 142 receives a set of outputs 612 from the machine learning model 130. At operation 708, the processing engine 142 accesses expected outputs 614 associated with the historical records 616 related to the set of real-world input data 610.

At operation 710, the processing engine 142 determines whether the output(s) 612 correspond to the counterpart expected output(s) 614. If it is determined that more than a threshold percentage 618 of the outputs 612 do not correspond to the counterpart expected outputs 614, the method 700 proceeds to operation 714. Otherwise, the method 700 proceeds to operation 712.

At operation 712, the processing engine 142 determines that the machine learning model 130 is not biased. At operation 714, the processing engine 142 determines that the machine learning model 130 is biased, i.e., in response to detecting a bias 224 and/or 620.

At operation 716, the processing engine 142 performs one or more corrective actions 622. Examples of the corrective actions 622 are described in FIG. 6. At operation 718, the processing engine 142 updates the machine learning model 130.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system for mitigating biases during testing of a machine learning model, comprising:
a memory configured to store a machine learning model and a training dataset, wherein the training dataset comprises a set of datapoints; and
a processor, operably coupled to the memory, and configured to:
access the machine learning model, wherein the machine learning model is trained using the training dataset;
test the machine learning model, wherein testing the machine learning model comprises:
inputting a set of real-world input data to the machine learning model;
receiving a set of outputs from the machine learning model; and
evaluating at least one of the set of outputs against a respective expected output, wherein the respective expected output is determined based at least in part upon a historical record associated with the set of real-world input data;
determine that more than a threshold percentage of outputs from among the set of outputs differ from respective expected outputs;
in response determining that more than the threshold percentage of outputs from among the set of outputs differ from respective expected outputs, determine that the machine learning model is biased; and
in response to determining that the machine learning model is biased, perform one or more corrective actions, wherein the one or more corrective actions comprise adjusting one or more parameters associated with the machine learning model, wherein the one or more parameters comprise a weight value or a bias value.

2. The system of claim 1, wherein the one or more corrective actions further comprise:
identifying a second datapoint, within the training dataset, that is associated with an incorrect label compared to a counterpart expected datapoint;
identifying a second label associated with the counterpart expected datapoint;
associating the second datapoint to the second label; and
retraining the machine learning model using a revised training dataset that comprises the second datapoint associated with the second label.

3. The system of claim 1, wherein the one or more corrective actions further comprise:
identifying a third datapoint, within the training dataset, that is incompatible with the machine learning model;
generating an updated third datapoint with a first data structure that is compatible with the machine learning model; and
retraining the machine learning model using a revised training dataset that comprises the updated third datapoint.

4. The system of claim 3, wherein determining that the third datapoint is incompatible with the machine learning model comprises:
determining that the machine learning model is configured to accept the first data structure;
determining that the third datapoint is associated with a second data structure; and
determining that the second data structure does not correspond with the first data structure.

5. The system of claim 1, wherein the one or more corrective actions further comprise:
determining that a fifth label associated with a fifth datapoint, within the training dataset, is incompatible with the machine learning model;
generating an updated fifth label with a third data structure that is compatible with the machine learning model; and
retraining the machine learning model using a revised training dataset that comprises the fifth datapoint associated with the updated fifth label.

6. The system of claim 1, wherein the one or more corrective actions further comprise:
accessing a set of expected datapoints that is expected to be present in the training dataset;
comparing each of the set of datapoints with a counterpart expected datapoint from among the set of expected datapoints;
determining that a fourth datapoint is missing from the training dataset based at least in part upon determining that the fourth datapoint is found in the set of expected datapoints;
adding the fourth datapoint to the training dataset; and
retraining the machine learning model using a revised training dataset that comprises the fourth datapoint.

7. The system of claim 1, wherein the one or more corrective actions further comprise:
identifying a first datapoint, within the training dataset, that is missing a first label;
adding the first label to the first datapoint; and
retraining the machine learning model with a revised training dataset that comprises the first datapoint associated with the first label.

8. A method for mitigating biases during testing of a machine learning model, comprising:
storing a machine learning model and a training dataset, wherein the training dataset comprises a set of datapoints;
accessing the machine learning model, wherein the machine learning model is trained using the training dataset;
testing the machine learning model, wherein testing the machine learning model comprises:
inputting a set of real-world input data to the machine learning model;
receiving a set of outputs from the machine learning model; and
evaluating at least one of the set of outputs against a respective expected output, wherein the respective expected output is determined based at least in part upon a historical record associated with the set of real-world input data;
determining that more than a threshold percentage of outputs from among the set of outputs differ from respective expected outputs;
in response determining that more than the threshold percentage of outputs from among the set of outputs differ from respective expected outputs, determining that the machine learning model is biased; and
in response to determining that the machine learning model is biased, performing one or more corrective actions, wherein the one or more corrective actions comprise adjusting one or more parameters associated with the machine learning model, wherein the one or more parameters comprise a weight value or a bias value.

9. The method of claim 8, wherein the one or more corrective actions further comprise:
identifying a second datapoint, within the training dataset, that is associated with an incorrect label compared to a counterpart expected datapoint;
identifying a second label associated with the counterpart expected datapoint;
associating the second datapoint to the second label; and
retraining the machine learning model using a revised training dataset that comprises the second datapoint associated with the second label.

10. The method of claim 8, wherein the one or more corrective actions further comprise:
identifying a third datapoint, within the training dataset, that is incompatible with the machine learning model;
generating an updated third datapoint with a first data structure that is compatible with the machine learning model; and
retraining the machine learning model using a revised training dataset that comprises the updated third datapoint.

11. The method of claim 10, wherein determining that the third datapoint is incompatible with the machine learning model comprises:
determining that the machine learning model is configured to accept the first data structure;
determining that the third datapoint is associated with a second data structure; and
determining that the second data structure does not correspond with the first data structure.

12. The method of claim 8, wherein the one or more corrective actions further comprise:
determining that a fifth label associated with a fifth datapoint, within the training dataset, is incompatible with the machine learning model;
generating an updated fifth label with a third data structure that is compatible with the machine learning model; and
retraining the machine learning model using a revised training dataset that comprises the fifth datapoint associated with the updated fifth label.

13. The method of claim 8, wherein the one or more corrective actions further comprise:
accessing a set of expected datapoints that is expected to be present in the training dataset;
comparing each of the set of datapoints with a counterpart expected datapoint from among the set of expected datapoints;
determining that a fourth datapoint is missing from the training dataset based at least in part upon determining that the fourth datapoint is found in the set of expected datapoints;
adding the fourth datapoint to the training dataset; and
retraining the machine learning model using a revised training dataset that comprises the fourth datapoint.

14. The method of claim 8, wherein the one or more corrective actions further comprise:
identifying a first datapoint, within the training dataset, that is missing a first label;
adding the first label to the first datapoint; and
retraining the machine learning model with a revised training dataset that comprises the first datapoint associated with the first label.

15. A non-transitory computer-readable medium storing instructions that, when executed by a processor, cause the processor to:
store a machine learning model and a training dataset, wherein the training dataset comprises a set of datapoints;
access the machine learning model, wherein the machine learning model is trained using the training dataset;
test the machine learning model, wherein testing the machine learning model comprises:
inputting a set of real-world input data to the machine learning model;
receiving a set of outputs from the machine learning model; and
evaluating at least one of the set of outputs against a respective expected output, wherein the respective expected output is determined based at least in part upon a historical record associated with the set of real-world input data;
determine that more than a threshold percentage of outputs from among the set of outputs differ from respective expected outputs;
in response determining that more than the threshold percentage of outputs from among the set of outputs differ from respective expected outputs, determine that the machine learning model is biased; and
in response to determining that the machine learning model is biased, perform one or more corrective actions, wherein the one or more corrective actions comprise adjusting one or more parameters associated with the machine learning model, wherein the one or more parameters comprise a weight value or a bias value.

16. The non-transitory computer-readable medium of claim 15, wherein the one or more corrective actions further comprise:
identifying a second datapoint, within the training dataset, that is associated with an incorrect label compared to a counterpart expected datapoint;
identifying a second label associated with the counterpart expected datapoint;
associating the second datapoint to the second label; and
retraining the machine learning model using a revised training dataset that comprises the second datapoint associated with the second label.

17. The non-transitory computer-readable medium of claim 15, wherein the one or more corrective actions further comprise:
identifying a third datapoint, within the training dataset, that is incompatible with the machine learning model;
generating an updated third datapoint with a first data structure that is compatible with the machine learning model; and
retraining the machine learning model using a revised training dataset that comprises the updated third datapoint.

18. The non-transitory computer-readable medium of claim 17, wherein determining that the third datapoint is incompatible with the machine learning model comprises:
determining that the machine learning model is configured to accept the first data structure;
determining that the third datapoint is associated with a second data structure; and
determining that the second data structure does not correspond with the first data structure.

19. The non-transitory computer-readable medium of claim 15, wherein the one or more corrective actions further comprise:
determining that a fifth label associated with a fifth datapoint, within the training dataset, is incompatible with the machine learning model;
generating an updated fifth label with a third data structure that is compatible with the machine learning model; and
retraining the machine learning model using a revised training dataset that comprises the fifth datapoint associated with the updated fifth label.

20. The non-transitory computer-readable medium of claim 15, wherein the instructions further cause the processor to determine that an accuracy score associated with the machine learning model is less than a threshold score, wherein determining that the machine learning model is biased is in response to determining that the accuracy score associated with the machine learning model is less than the threshold score.
